(19) United States
(12) Patent Application Publication
(10) Pub. No.: US 2020/0044308 A1
(43) Pub. Date: Feb. 6, 2020

(54) ANTENNA SYSTEM AND MOBILE TERMINAL

(71) Applicant: AAC Technologies Pte. Ltd., Singapore City (SG)

(72) Inventors: Yunghit Chan, Shenzhen (CN); Guanhong Ng, Shenzhen (CN); Yewsiow Tay, Shenzhen (CN)

(21) Appl. No.: 16/527,073

(22) Filed: Jul. 31, 2019

(30) Foreign Application Priority Data
Aug. 3, 2018 (CN) 201810875656.6

(51) Int. Cl. H01Q 1/24; H01Q 1/36; H01Q 1/48; H04B 1/3827

(52) U.S. Cl. CPC H01Q 1/241; H04B 1/3827; H01Q 1/48; H01Q 1/36

(57) ABSTRACT

An antenna system including a dual-frequency antenna, and a mobile terminal including the antenna system are provided. The terminal includes a metal housing, a printed circuit board, and a liquid crystal screen component arranged in sequence. The metal housing includes an end portion and a first notch close to the end portion, a semi-closed notch is provided at a position of the printed circuit board corresponding to the first notch, and the dual-frequency antenna is disposed at the semi-closed notch and is fixed to the semi-closed notch by a plastic filler and aligned with the first notch of the metal housing, thereby solving the problem that the metal housing cannot radiate antenna or the radiation signal is weak and realizing a large degree of radiation. The plastic filler includes ABS resin or PC-ABS resin, which enhances impact resistance, heat resistance, and low temperature resistance of the antenna.

### TECHNICAL FIELD

The present disclosure relates to the field of mobile terminals, and particularly, to an antenna system and a mobile terminal device using the antenna system.

### BACKGROUND

Currently, with popularity of intelligence of mobile terminals, consumers are increasingly demanding appearance aesthetics of various mobile terminals. Metal is being increasingly recognized by consumers because it has good appearance and wear resistance, high quality of luster and texture, and thus design of the mobile terminals has gradually updated from a cheap plastic material body to a full metal body.

Appearance design of such a metal back cover is good to the designers and terminal users, but it is a challenge for antenna engineers because electromagnetic waves cannot penetrate metal, so a full-closed metal back cover cannot be used for antenna radiation since it will directly damage signal strength of an antenna module and affect user experience of mobile terminal.

Therefore, it is necessary to provide a mobile terminal having good antenna radiation performance to solve the above problem.

### BRIEF DESCRIPTION OF DRAWINGS

FIG. 1 is a perspective view of a mobile terminal of the present disclosure;

FIG. 2 is an exploded view of the mobile terminal of the present disclosure;

FIG. 3 is a partially enlarged view of portion A in the exploded view of FIG. 2;

FIG. 4 is a cross-sectional view taken along a line B-B in the exploded view of FIG. 2;

FIG. 5 is a structure schematic diagram of a dual-frequency antenna in the mobile terminal of the present disclosure;

FIG. 6 is a return loss graph of the dual-frequency antenna according to the present disclosure;

FIG. 7 is an analog measurement efficiency graph of a frequency band of 2400 MHz to 2500 MHz of the dual-frequency antenna according to the present disclosure; and

FIG. 8 is an analog measurement efficiency graph of a frequency band of 5150 MHz to 5850 MHz of the dual-frequency antenna according to the present disclosure.

### DESCRIPTION OF EMBODIMENTS

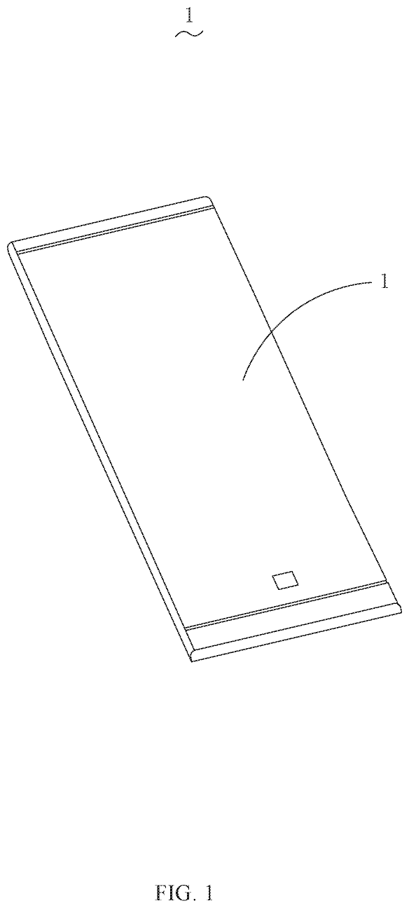

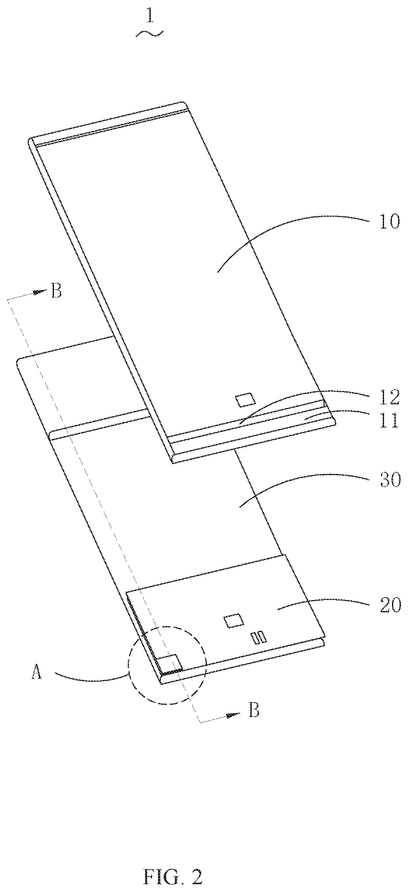

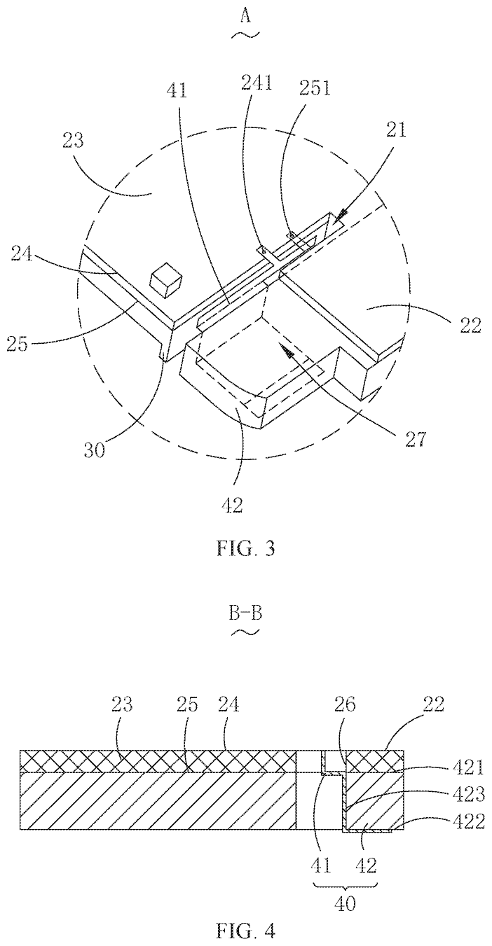

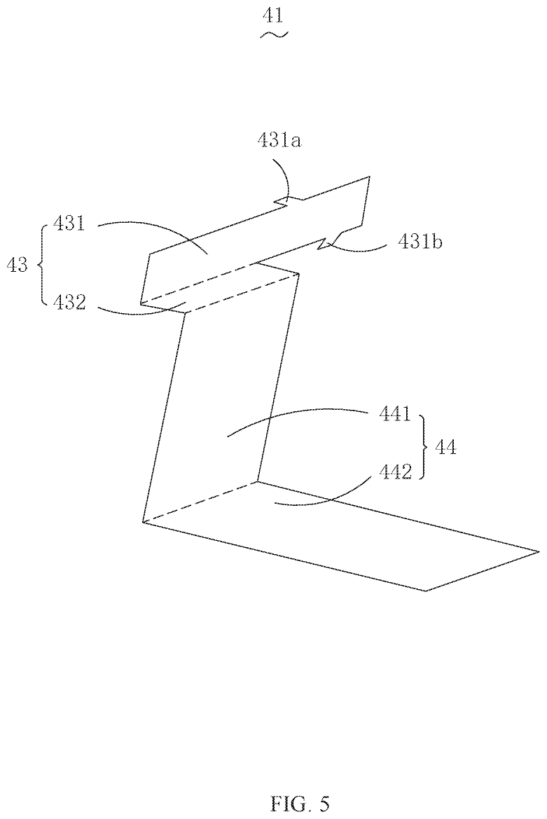

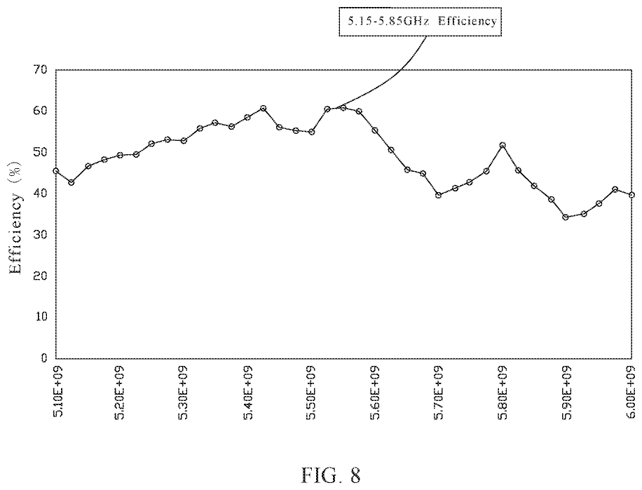

The present disclosure is described in detail below with reference to FIG. 1 to FIG. 8.

As shown in FIG. 1 to FIG. 5, a mobile terminal 1 according to the present disclosure includes a metal housing 10, a printed circuit board 20, and a liquid crystal screen component 30 which are arranged in sequence, and further includes an antenna system 40.

The metal housing 10 includes an end portion 11 and a first notch 12 close to the end portion 11. A semi-closed notch 21 is provided at a position of the printed circuit board 20 corresponding to the first notch 12, the printed circuit board 20 includes a first portion 22 located on a side of the semi-closed notch 21 close to the end portion 11 and a second portion 23 on a side of the semi-closed notch 21 facing away from the end portion 11, and the printed circuit board 20 further includes an upper end surface 24 facing towards the metal housing 10 and a lower end surface 25 facing towards the liquid crystal screen component 30. The semi-closed notch 21 includes a first side wall 26 connecting the upper end surface 24 to the lower end surface 25 and abutting the first portion 22. The upper end surface 24 is provided with a feeding point 241, the lower end surface 25 is provided with a grounding point 251, and the feeding point 241 and the grounding point 251 are both located at the second portion 23. Projection of the semi-closed notch 21 in a direction perpendicular to the upper end surface 24 is rectangular. The semi-closed notch 21 has a length of 14 mm to 18 mm and a width of 1.4 mm to 1.6 mm, optionally a length of 16 mm and a width of 1.5 mm.

The antenna system 40 includes a dual-frequency antenna 41 and a bracket 42 on a side of the lower end surface 25 of the printed circuit board 20. The dual-frequency antenna 41 includes a body portion 43 and an extension portion 44 connected to each other. The body portion 43 includes a first vertical portion 431 inserted into the semi-closed notch 21 and parallel to the first sidewall 26, and a first horizontal portion 432 extending horizontally from one end of the first vertical portion 431 close to the lower end surface 25 toward the first portion 22, the first horizontal portion 432 being located in a plane where the lower end surface 25 is located. The body portion 43 further includes a feeding end 431a extending from one end of the first vertical portion 431 close to the upper end surface 24 toward the second portion 23, and a grounding end 431b extending from one end of the first vertical portion 431 close to the lower end surface 25 toward the second portion 23. The feeding end 431a is connected to the feeding point 241 and the grounding end 431b is connected to the grounding point 251, and the first horizontal portion 432 is spaced apart from the grounding end 431b. In this embodiment, the semi-closed notch 21 is filled with a plastic filler which is ABS resin or PC-ABS resin, the body portion 43 is fixed in the plastic filler, and the first vertical portion 431 is located at a middle position of the semi-closed notch 21, optionally at a central position of the semi-closed notch 21. The extension portion 44 includes a second vertical portion 441 which extends vertically from one end of the first horizontal portion 432 facing away from the first vertical portion 431 toward a direction facing away from the printed circuit board 20 and which is located in a plane where the first side wall 26 is located, and a second horizontal portion 442 which extends horizontally from one end of the second vertical portion 441 facing away from the first horizontal portion 432 toward a side close to the first portion 22. Operating bands of the antenna system 40 are 2400 MHz to 2500 MHz and 5150 MHz to 5850 MHz.

The bracket 42 includes an upper surface 421 facing towards the lower end surface 25, a lower surface 422 disposed opposite to the upper surface 421, and a second side wall 423 connecting the upper surface 421 to the lower surface 422. The second vertical portion 441 is disposed on the second side wall 423, and the second horizontal portion 442 is disposed on the lower surface 422.

In this embodiment, a clearance area 27 is provided on the first portion 22 of the printed circuit board 20, and an orthographic projection of the second horizontal portion 442 on the printed circuit board 20 is located in the clearance area 27. The semi-closed notch 21 has no electric conductor in a projection area of the vertical upper end surface 24; the clearance area 27 has a length of 5 mm to 9 mm in a direction parallel to the semi-closed notch 21, optionally a length of 7 mm in a direction parallel to the semi-closed notch 21.

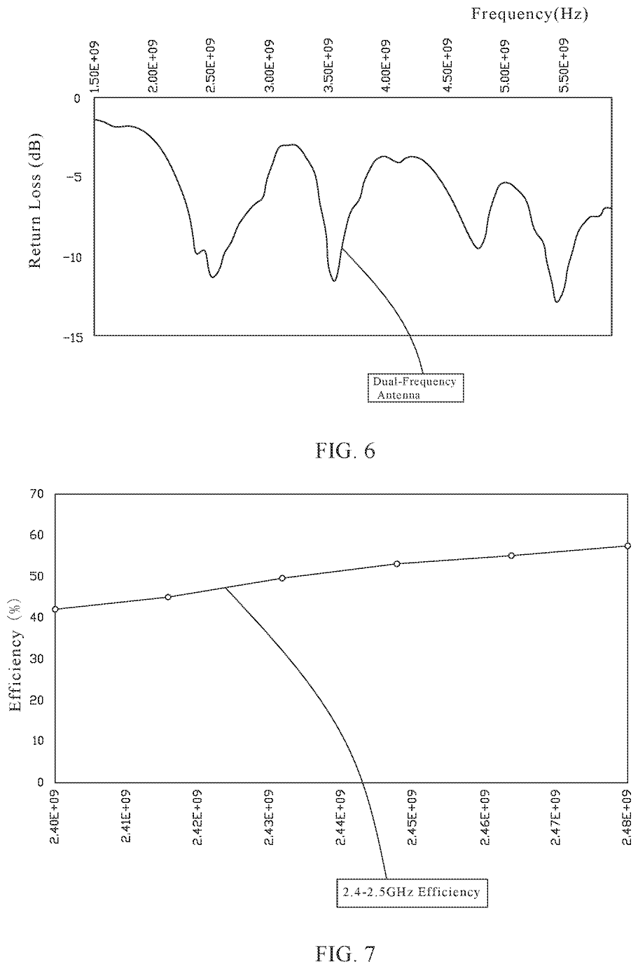

The results are shown in FIG. 6 to FIG. 8 by testing return loss and efficiency of the antenna system 40 of the mobile terminal 1. As can be seen from the drawings, efficiency of the dual-frequency antenna 40 in a frequency band of 2400 MHz to 2500 MHz is greater than 40%, and efficiency in a frequency band of 5150 MHz to 5850 MHz is greater than 35%.

The mobile terminal according to the present disclosure includes a dual-frequency antenna and a plastic groove of a metal housing aligned with the dual-frequency antenna, which solves the problem that the metal housing cannot radiate antenna or the radiation signal is weak and realizes a large degree of radiation. The dual-frequency antenna works through dual frequency, so that coverage of the antenna is wider. The antenna structure is extended to the liquid crystal screen, so that the dual-frequency antenna can receive signals better. The mobile terminal uses ABS resin or PC-ABS resin to fill the plastic groove on the metal housing, which enhances the impact resistance, heat resistance, and low temperature resistance of the antenna.

The above-described are only embodiments of the present disclosure. It should be noted here that for a person of ordinary skill in the art, improvement may be made without departing from the creative spirit of the present disclosure. These all fall within the scope of protection of the present disclosure.

What is claimed is:

1. An antenna system, applied in a mobile terminal, the mobile terminal comprising a metal housing, a printed circuit board, and a liquid crystal screen component which are arranged in sequence, wherein the antenna system comprises:
a dual-frequency antenna,
wherein the metal housing comprises an end portion and a first notch close to the end portion, a semi-closed notch is provided at a position of the printed circuit board corresponding to the first notch, and the printed circuit board comprises a first portion located on a side of the semi-closed notch close to the end portion and a second portion located on a side of the semi-closed notch facing away from the end portion;
the printed circuit board further comprises an upper end surface facing toward the metal housing and a lower end surface facing toward the liquid crystal screen component, the semi-closed notch comprises a first side wall connecting the upper end surface to the lower end surface and abutting the first portion, the upper end surface is provided with a feeding point, the lower end surface is provided with a grounding point, and the feeding point and the grounding point are both located at the second portion;
the dual-frequency antenna comprises a body portion and an extension portion connected to each other, the body portion comprises a first vertical portion inserted into the semi-closed notch and parallel to the first side wall, the body portion further comprises a feeding end extending from one end of the first vertical portion close to the upper end surface toward the second portion and a grounding end extending from one end of the first vertical portion close to the lower end surface toward the second portion, the feeding end being connected to the feeding point and the grounding end being connected to the grounding point, and the body portion further comprises a first horizontal portion extending horizontally from one end of the first vertical portion close to the lower end surface toward the first portion, the first horizontal portion being located in a plane where the lower end surface is located; and
the extension portion comprises a second vertical portion extending vertically from one end of the first horizontal portion facing away from the first vertical portion along a direction facing away from the printed circuit board and being located in a plane where the first side wall is located, and a second horizontal portion extending horizontally from one end of the second vertical portion facing away from the first horizontal portion toward a side close to the first portion.

2. The antenna system as described in claim 1, wherein the semi-closed notch is filled with a plastic filler, the body portion is fixed into the plastic filler, and the plastic filler is ABS resin or PC-ABS resin.

3. The antenna system as described in claim 1, further comprising a bracket on a side of the lower end surface of the printed circuit board, the bracket comprising an upper surface facing toward the lower end surface, a lower surface disposed opposite to the upper surface, and a second side wall connecting the upper surface to the lower surface, wherein the second vertical portion is disposed on the second side wall, and the second horizontal portion is disposed on the lower surface.

4. The antenna system as described in claim 1, wherein the first vertical portion is located at a middle position of the semi-closed notch.

5. The antenna system as described in claim 1, wherein the first horizontal portion is spaced apart from the grounding end.

6. The antenna system as described in claim 1, wherein a projection of the semi-closed notch along a direction perpendicular to the upper end surface is rectangular, and the semi-closed notch has a length of 14 mm to 18 mm and a width of 1.4 mm to 1.6 mm.

7. The antenna system as described in claim 1, wherein a clearance area is provided on the first portion of the printed circuit board, an orthographic projection of the second horizontal portion on the printed circuit board is located in the clearance area, and the semi-closed notch has no electric conductor in a projection area of the upper end surface along a direction perpendicular to the upper end surface.

8. The antenna system as described in claim 6, wherein operating bands of the antenna system are 2400 MHz to 2500 MHz and 5150 MHz to 5850 MHz.

9. The antenna system as described in claim 1, wherein the dual-frequency antenna is made of a flexible circuit board.

10. A mobile terminal, comprising the antenna system as described in claim 1.

11. A mobile terminal, comprising the antenna system as described in claim 2.
